(19) United States
(12) Patent Application Publication
(10) Pub. No.: US 2005/0119930 A1
(43) Pub. Date: Jun. 2, 2005

(54) Combined scheduling and management of work orders, such as for utility meter reading and utility servicing events

(75) Inventor: Robert Simon, Rathdrum, ID (US)

Correspondence Address: PERKINS COIE LLP;PATENT-SEA, P.O. BOX 1247, SEATTLE, WA, 98111-1247, US

(73) Assignee: Itron, Inc., Spokane, WA (US)

(21) Appl. No.: 10/971,720

(22) Filed: Oct. 21, 2004

Related U.S. Application Data
(60) Provisional application No. 60/513,485, filed on Oct. 21, 2003.

(51) Int. Cl. G06F 17/60

(52) U.S. Cl. 705/9

(57) ABSTRACT

A system and method manages work requests used in reading and servicing gas, electric, or water meters in a utility system. A work request may originate at a utility system and is received at a data collection system. The work request may be generated based on an underlying data structure. The underlying data structure may be used in generating requests for multiple types of work events, including meter monitoring work events and meter servicing work events. The work request is then processed to generate a work order which is transmitted to a field device component or other component of the system so that work may be performed as directed in the request.

### CROSS-REFERENCE TO RELATED APPLICATION

This application claims priority to U.S. Provisional Patent Application No. 60/513,485, filed Oct. 21, 2003, which is herein incorporated by reference.

### BACKGROUND

A typical utility provider (e.g., gas utility, water utility, electrical utility, etc.) is often responsible for managing multiple meters that provide information about utility usage by its customers. Management of utility meters may include tasks such as meter reading and meter servicing. Such meters are typically read and/or serviced on a periodic basis. For example, the utility provider may schedule its meters for reading or servicing on a monthly basis, on an annual basis, or as otherwise needed. Often, the utility provider groups its meters into meter reading routes (with each route typically consisting of a group of meters within a given geographical area).

Existing meter management systems often dictate that utility providers handle meter reading events separately from meter servicing events and other utility servicing events. For example a meter reading technician may handle meter reading events on a route, while a meter servicing technician separately handles meter servicing events on the same route. In addition, an infrastructure technician may handle servicing of utility infrastructure (e.g., meter connections, transmission components, etc.).

To facilitate meter reading and servicing, utility providers may implement a variety of meter management techniques such as electronic meter reading (EMR), off-site meter reading (OMR), and automatic meter reading (AMR), some or all of which may include computerized or automated functionality. Because utility providers may employ more than one meter management technique within a single utility system, handling meter reading and meter servicing events becomes even more complex.

For example, with EMR, handheld computers with integrated meter reading software may be used to capture and store meter reading data from electric, gas, or water meters. Additionally, EMR systems may collect non-meter reading information, including meter condition, hazardous conditions, tamper information, survey data, and high/low reading checks. Typically, with EMR, a meter reader walks a specified route, visually reading meters and entering meter reading data into the handheld computer. The meter reading data is recorded and stored in the handheld computer. The meter reading data is eventually transferred to a host processor, which then transfers the data to a utility billing system, etc. EMR systems can also incorporate readings gathered by probing meters, as is the case with time-of-use meters and interval data recorders. EMR systems can also probe water meters using inductive probes, etc.

OMR uses radio-equipped handheld computers to read module-equipped electric, gas, or water meters via radio. This enables the meter to be read without directly accessing the meter or the premise. With OMR, as a meter reader walks a route, the radio-equipped handheld computer sends a radio “wake-up” signal to nearby radio-based meter modules installed on electric, gas or water meters. OMR may also use bubble up techniques where the radio-based meter modules send the information at some configurable time interval (e.g., every five seconds). The handheld computer then receives meter reading and tamper data back from the meter modules. OMR is normally used to read meters within a utility service territory that are otherwise hazardous or costly to read. Such meters are typically located in a geographically dispersed environment, for example, scattered throughout the service territory.

Mobile AMR uses vehicles equipped with radio units to read electric, gas, or water meters equipped with receiver/transmitter modules. Meter reading can then take place via radio without the need to access the meter. A radio transceiver is installed in a utility vehicle and route information is specified. While being driven along the specified meter reading route, the transceiver broadcasts a radio wake-up signal to all radio-based meter modules within its range and receives messages in response. Completed reads may be uploaded to a billing system. Mobile AMR is usually used in saturated areas where there may be difficult-to-access or hazardous-to-read meters or large populations. Like OMR, mobile AMR can use both wakeup and bubble up techniques for transmission of data.

Fixed network AMR uses a fixed radio communication network to collect data from electric, gas, or water meters equipped with radio-based meter modules. The collected data is transported over a wide-area communication network to a central host processor. Control units installed on power poles or street lights function as neighborhood concentrators that read meter modules, process data into a variety of applications, store data temporarily, and periodically transport data to the host processor.

Fixed network AMR is usually installed over saturated areas where advanced metering data, variable reads, and unscheduled reads are needed. Saturated deployment spreads the cost of the network components over multiple meters.

### BRIEF DESCRIPTION OF THE DRAWINGS

FIG. 1 is a block diagram showing a first example of a system on which the work management technique can be implemented in one embodiment.

FIG. 2 is a block diagram showing a second example of a system on which the work management technique can be implemented in an alternate embodiment.

FIG. 3 is a class diagram showing various examples of work data types for use in the systems of FIGS. 1 and 2.

FIG. 4A is a class diagram showing the relationship between the work data types of FIG. 3 and other system data types.

FIG. 4B is a class diagram showing the relationship between the work data types of FIG. 3 and other system data types in an alternative embodiment.

FIG. 5 is a class diagram showing the relationship of a routed set of work (including pure meter reading routes) to a generic collection of work.

FIG. 6 is a flow diagram showing examples of work-related routines performed at the system of FIG. 1.

FIG. 7 is a flow diagram showing examples of work-related routines performed at the system of FIG. 2.

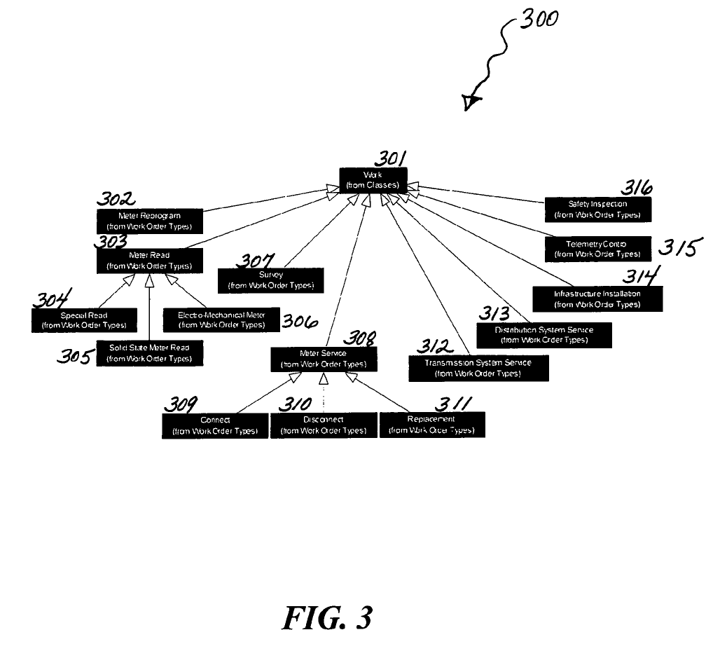

The headings provided herein are for convenience only and do not necessarily affect the scope or meaning of the claimed invention. In the drawings, the same reference numbers identify identical or substantially similar elements or acts. To easily identify the discussion of any particular element or act, the most significant digit or digits in a reference number refer to the Figure number in which that element is first introduced (e.g., element 304 is first introduced and discussed with respect to FIG. 3).

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Overview

A technique for routing and processing work requests within a utility system (e.g., electric, gas, water utility) is described herein. In some embodiments, the technique allows for managing a set of utility systems using a single interface. For example, the technique allows a meter reading department, a field service department, and a joint meter reading/field service department to use a single work order scheduling interface to schedule both meter reading and field service work orders. In some embodiments, the single interface can be used to schedule a single field service work order, a single meter read, a group of field service work orders, a group of meter reads, a combination of meter reading and service work orders, etc.

The management of utility meters and utility infrastructure can be defined in terms of events that typically involve work. For example, a utility meter may be read, reprogrammed, surveyed, serviced, etc. Likewise, work related to utility infrastructure might include activities such as repairing a broken pole, trimming trees away from a line, repairing a line or pipeline, etc. These general events can be broken down even further. For example, a meter service event may be a connection event, a disconnection event, a replacement event, a verification event, etc. Likewise, a meter reading event can be a solid state meter read, an electromechanical meter read, a special type of meter read, and so on.

In some embodiments, generalized information entity is used to facilitate using a single interface for scheduling these and similar events. This generalized information entity is referred to herein as “work” or a “work order.” For example, in an object oriented programming design, various types of meter events (e.g., service, reading, special reading, etc.) may be implemented using data types that inherit from a general work entity or class.

Because a worker rarely performs work on an individual meter as an isolated event, the technique may provide for a collection of work orders (e.g., a work collection). In an object oriented design, the technique may represent a work collection as a WorkCollection class. The configuration of the WorkCollection class may allow more specialized work collection classes to be derived from it. For example, a specialized work order collection may be a “route” used to organize a collection of meter or utility management events taking place in a specific geographic area. Examples include meter reading routes, field service routes, or combined meter reading field service routes. The work orders in the route can be assigned to one or more individuals and may be scheduled to take place over a set period of time. In this way, a meter reading and a field service request can be assigned to the same person. Scheduling work may be the first step in the process. After the work is completed, a meter reading system may gather data and perform updates, etc.

By facilitating a single interface for providing and processing work requests, the technique simplifies the task of specifying and scheduling work. In addition, the technique may be easily adaptable to handle varying meter reading and field service systems and technologies, without departing from the single interface. This allows for convenience and flexibility.

II. System Architecture

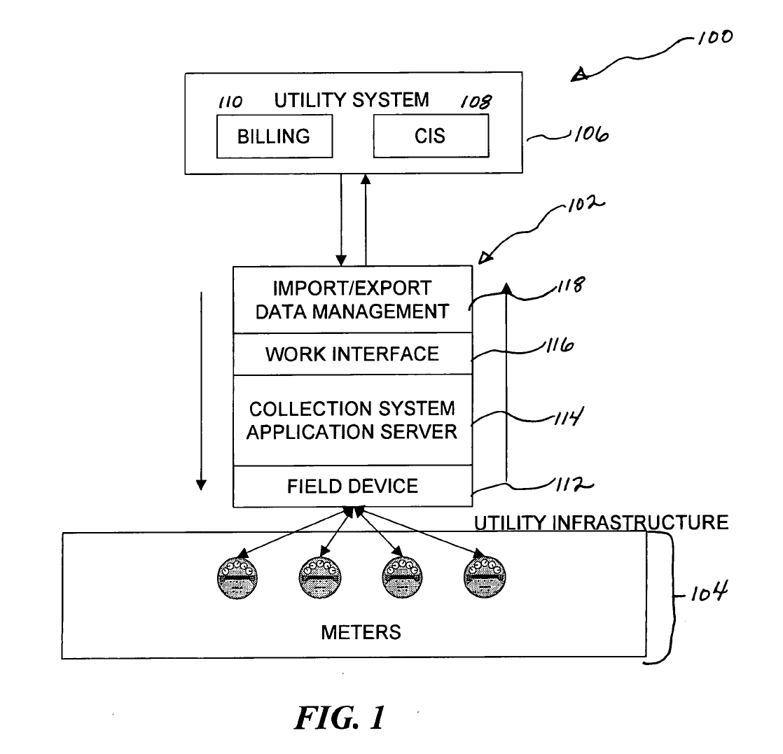

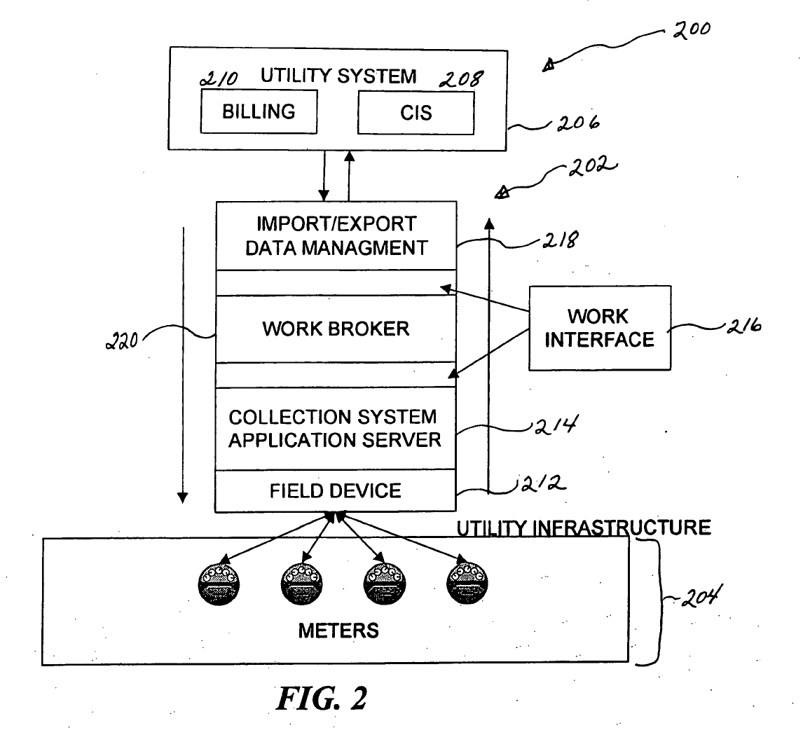

FIGS. 1, 2, and the following discussion provide a brief, general description of a suitable computing environment in which the invention can be implemented. Although not required, aspects of the invention are described in the general context of computer-executable instructions, such as routines executed by a general-purpose computer, e.g., a server computer, wireless device or personal computer. Those skilled in the relevant art will appreciate that the invention can be practiced with other communications, data processing or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers and the like. Indeed, the terms “computer,” “host” and “host computer“are generally used interchangeably, and refer to any of the above devices and systems, as well as any data processor.

Aspects of the invention can be embodied in a special purpose computer or data processor that is specifically programmed, configured or constructed to perform one or more of the computer-executable instructions explained in detail herein. Aspects of the invention can also be practiced in distributed computing environments where tasks or modules are performed by remote processing devices, which are linked through a communications network. In a distributed computing environment, program modules may be located in both local and remote memory storage devices.

Aspects of the invention may be stored or distributed on computer-readable media, including magnetically or optically readable computer discs, as microcode on semiconductor memory, nanotechnology memory, or other portable data storage medium. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched or other scheme). Those skilled in the relevant art will recognize that portions of the invention reside on a server computer, while corresponding portions reside on a client computer such as a mobile device.

FIG. 1 is a block diagram showing an example of a meter reading/field service (MR/FS) system 100 in which the work management technique can be implemented. FIG. 2 is a similar block diagram showing an example of a second MR/FS system 200 on which the work management technique can be implemented in an alternate embodiment.

Referring to FIG. 1, a collection system 102 serves as an intermediate subsystem between a utility infrastructure, including a collection of meters 104, and a utility provider's customer system 106. The utility provider may be, for example, an electric company, a gas company, a water district, etc. The collection system 102 communicates with a customer information system (CIS) 108 at the utility provider. In general, the CIS 108 provides importable data such as requests that specify a type of work to be performed (e.g., field service or meter reading). In some cases, the importable data may be created as a file, an object in a message queue, or a message on another transport mechanism. While the transport mechanism may vary, the format of the data over the given transport may remain consistent (or may also vary). The utility system may also include a billing system 1 10.

The collection system 102 may include multiple components or layers. For example, a field device layer 112, consisting of, for example, handheld computers, collector units, etc., may communicate with the collection of meters 104. While the details of the field device layer 112 are not shown, the field service layer may support any one of a variety of meter reading techniques including electronic meter reading (EMR), off-site meter-reading (OMR), automatic meter reading (AMR), etc.

The remaining components or layers, including a collection system application server (host processor) 114, a work interface 116, and an import/export data management layer 118, may handle the bulk of data processing and distribution for which the system 102 is responsible, including the handling of data relating to work orders for field service and meter reading. For example, the collection system application server 114 handles processing of work orders eventually downloaded to the field devices (so work can be performed) and work results uploaded from the field device. The collection system application server 114 may support various applications including meter reading applications, field service applications, telemetry applications, etc., depending on system needs.

The import/export data management layer 118 may provide a way to parse and format imported data (e.g., files containing requests for reading/servicing work) sent from the CIS 108 to the collection system 102 and exported data (e.g., files containing results for performed field service/meter reading work) sent from the collection system to the CIS. The import/export data management layer 118 may include a CIS data formatter component (not shown) for parsing files imported from the CIS 108.

The work interface (or IWorkCollection interface) 116 may communicate work data between sub-systems and services of the system. For example, the work interface 116 may function as an interface between the import/export data management layer 118 and the collection system application server 114. The work interface 116 may be designed to support both meter reading and field service work requests. Some of the methods associated with the work interface 116 are outlined below in Table 1.

TABLE 1
IWorkCollection Interface Methods

| Method Name | Function |
|---|---|
| Add([in] IWorkCollection[ ]) | Add a collection of work collections |
| | (e.g., a meter reading route) to a sub- |
| | system (e.g., mobile data meter data |
| | collection system). |
| Update([in] IworkCollection[ ]) | Update a collection of work collec- |
| | tions (e.g., a meter servicing route) to |
| | a subsystem (e.g., mobile data meter |
| | data collection system). |
| Remove([in] IworkCollection[ ]) | Remove a collection of work collec- |
| | tions (e.g., a meter reading/servicing |
| | route) to a subsystem (e.g., mobile |
| | data meter data collection system). |
| Contains([out] IworkCollection[ ]) | Determine what work order collec- |
| | tions (or routes) a sub-system con- |
| | tains. For example, this function may |
| | return descriptive information for the |
| | work collections (e.g., routes) and |
| | work order. In some embodiments, it |
| | this function is a query to see what |
| | work collections/work a sub-system |
| | contains. |

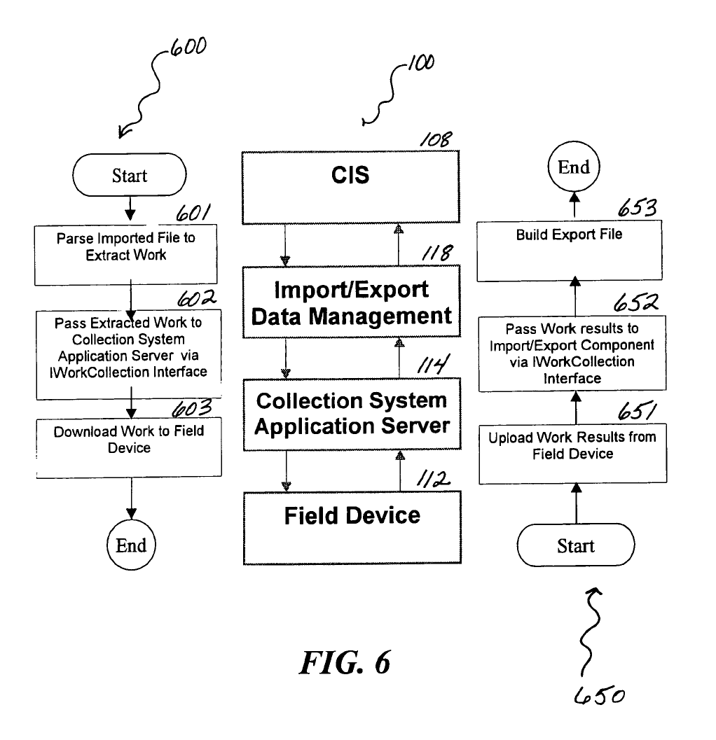

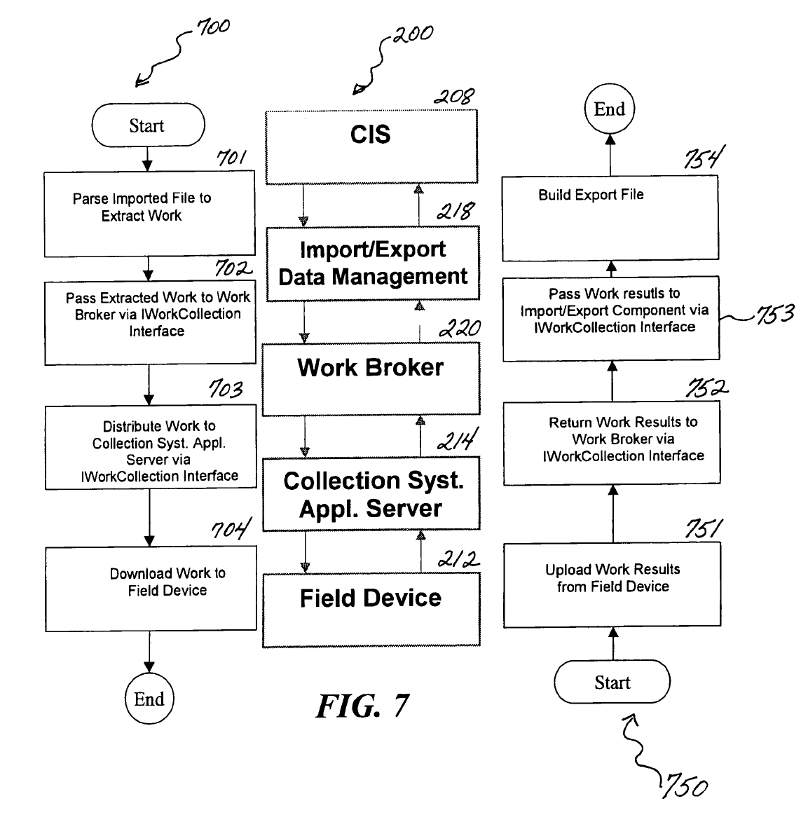

FIG. 2 is a block diagram showing an alternative meter reading/field service (MR/FS) system 200 in which the work management technique can be implemented. The system 200 may include a collection system 202 that serves as a high-level interface between a utility infrastructure, including a collection of meters 204, and a utility provider's customer system 206 having a CIS 208 and a billing system 210. Like the collection system 102 of FIG. 1, the collection system 202 may include multiple components or layers, including a field device layer 212, one or more collection system application servers 214, a work interface 216, and an import/export data management layer 218. Unlike the collection system 102 of FIG. 1, however, the collection system 202 of FIG. 2 may include a work broker 220 between the import/export data management layer 218 and the collection system application server 208. The addition of the work broker 220 may facilitate simultaneously supporting multiple meter-management techniques using a single interface. For example, in the system 200 some of the meters in the collection of meters 204 may be read using AMR techniques, while, at the same time, other meters in the collection may be read using EMR techniques, as discussed further with respect to FIGS. 6 and 7.

The collection system 202 may provide the work interface layer 216 provides an interface at both ends of the work broker 220. In addition, the collection system 202 may include multiple collection system application servers 214 and field device layers 212; one for each type of field service or meter management technique (e.g., EMR, AMR, OMR, etc.) that the system supports.

III. Data Model

Management of utility meters can be defined in terms of events that occur with respect to a utility infrastructure or at a utility meter or group of utility meters.

For example, a meter may be read, reprogrammed, surveyed, serviced, etc. In general, the various applications running on the utility system and/or the collection system (both described with respect to FIGS. 1 and 2) produce work or work orders associated with such events. Such work orders may originate as a request from the utility provider's system, or alternatively, as a result of some automated creation or scheduling feature within the collection system.

To allow work- and work order-related data to pass generically through the system and to allow the scheduling of work via a single interface, a generalized work entity or data type may be used. FIG. 3 shows an example of an object-oriented implementation of a work entity providing for such use. While an object-oriented implementation is described, the work entity or data type may be implemented using any one of a number of programming techniques (including non-object oriented programming techniques). In FIG. 3, the implementation is depicted as a class hierarchy 300.

Referring to FIG. 3, a work entity 301 serves as a base class from which several subclasses of work entity can be derived, for example, in an inheritance relationship. In some embodiments, attributes of the work entity 301 include an EXTERNAL ID attribute that may be used in identifying a work order in an external system in which the work order is ultimately received (e.g., a mobile data collection system).

The work entity 301 may also include a WORK TYPE attribute that indicates the type of work associated with the work order. Valid values for the WORK TYPE attribute may include meter read, connect, disconnect, meter reprogram, meter service, meter replacement, safety inspection, special read, survey, telemetry control, etc.

The work entity 301 may further include a DEFAULT COLLECTION TYPE attribute that indicates the default collection type for the work order. This attribute may help direct the work order to the right collection system/technology. Sample valid values for the DEFAULT COLLECTION TYPE attribute include, handheld, mobile collector, AMR cell control unit (CCU), etc.

In some embodiments, the work entity 301 also includes a SCHEDULED WORK DATE AND TIME attribute that indicates the date and time that the work is scheduled to be completed and a GPS INFORMATION attribute that specifies the location of the work to be performed (e.g., latitude, longitude, and other types of GPS information identifying the location of the work).

When used to represent a work order that is part of a set of work, the work entity 301 may include a WORK SET ID attribute that identifies the work set that the work order is an element of, a SEGMENT attribute that identifies a range of related work orders within the work set, and a SEQUENCE NUMBER attribute that identifies the current sequence of the work order in the work set.

A SOURCE attribute of the work entity 301 may identify a source from which the work order originated. Sample values for this attribute include, a CIS system, a field service application, a persistent store, an application server, a field device, etc. The work entity 301 may also include information to indicate a time that the work order was created.

The work entity 301 may also include information to support moving or copying work orders from one work set to another. This information may include a CHANGED WORK SET ID attribute that identifies the new work set that the work order is currently an element of, a LAST WORK SET ID attribute that identifies the previous work set the work order was an element of, and a WORKED COPIED flag that indicates whether the work has been copied to another work set. Likewise, a CHANGED SEQUENCE NUMBER attribute identifies the current sequence of the work order in the work set (if changed).

When implemented as a base class an object-oriented programming scheme, the work entity 301 may serve as a parent class for several derived classes. For example, in the illustrated embodiment, a meter reprogram class 302, which inherits from the work entity 301, corresponds with data for meter reprogramming events. A meter read class 303, which also inherits from the work entity 301, corresponds with data for meter reading events. Such derived classes may also serve as parent classes for additional derived classes. For example, the meter read class 303 in the illustrated embodiment serves as a parent class for a special read class 304, a solid state read class 305, and an electromechanical read class 306.

A survey class 307 represents another type of work event, as does a meter service class 308. Like the meter read class 303, the meter service class 308, serves as a parent class for additional subclasses (309, 310, and 311), each representing a different type of meter service event.

In addition to meter-related work, classes derived from the work entity 301 may also be used to represent other work types associated with a utility system including transmission system servicing (transmission system service class 312), distribution system servicing (distribution system service class 313), infrastructure installation (infrastructure installation class 314), telemetry control (telemetry control class 315), and safety inspection (safety inspection class 316).

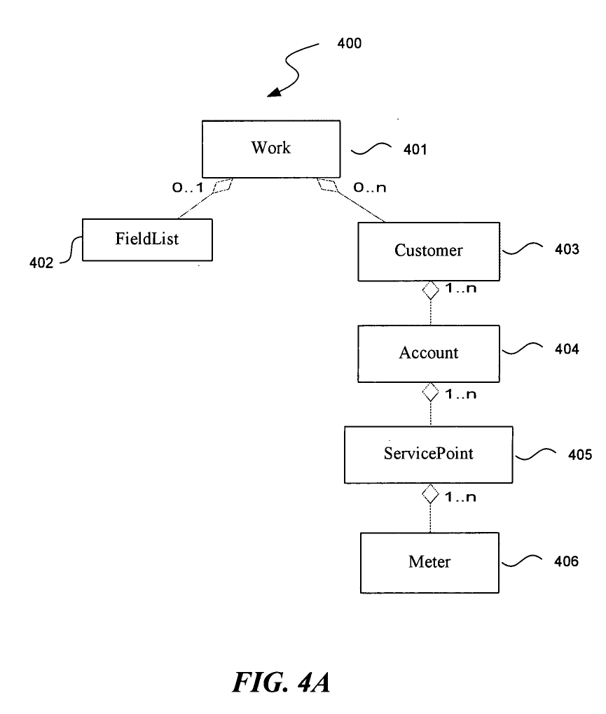

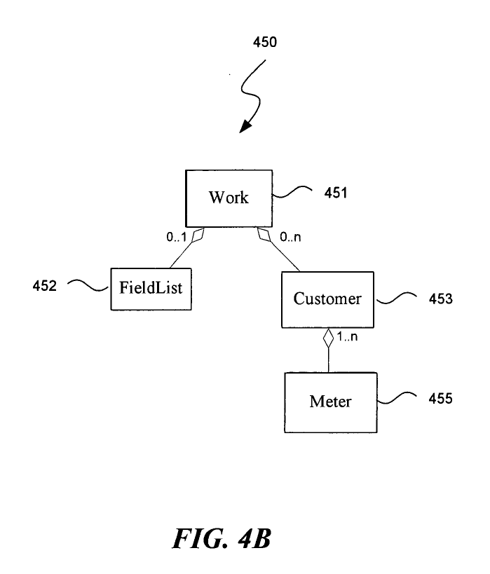

Because of its diverse use, a work entity, such as the work entity 301 of FIG. 3, may have a structure that is configured to support meter reading, field service, and many other types of work. For example, in when implemented using object oriented programming, the work entity may be implemented using an object structure 400 configured as a branching hierarchy, as shown in FIG. 4A. In the illustrated embodiment of the object structure 400, the left branch of the hierarchy relates to field service work orders and the right branch of the hierarchy 400 relates to meter centric data, which, in some cases, may be related to both meter reading and meter servicing. In general, a generic work object 401 at the top of the hierarchy may “contain” one or more related objects, sometimes referred to as a “has-a” relationship in object oriented programming. For example, in the context of field service work orders (left branch), the work object 401 contains a generic field list object 402. Use of the generic field list object 402 supports a variety of field service work orders, each having diverse data fields.

In the context of meter centric data, the generic work object 401 may contain a customer object 403, which contains an account object 404, which contains a service point object 405, which contains a meter object 406, respectively. This type of arrangement provides flexibility, in that it supports multiple customers per work order, multiple accounts per customer, multiple service points per account (including service points of different types), and multiple meters per service point (including meters of different types).

Referring to FIG. 4B, an alternative embodiment of a structure for a work entity, such as the work entity 301 of FIG. 3 may be implemented using an object structure 450, which is similar to the object structure of FIG. 4A, but configured as a branching hierarchy with a condensed right branch relating to meter-centric data. As shown, in the context of meter-centric data, a generic work object 451 may contain only a customer object 453 (with account information included as object attributes) and a meter object 455. While this type of configuration may be less flexible than the configuration of the object structure 400 of FIG. 4A (which includes separate account and service point objects—thereby allowing flexibility in terms of cardinality, etc.), it may increase performance by allowing the system to process fewer data types. Like the branching work hierarchy 400 of FIG. 4A, the left branch of the condensed hierarchy 450 may also include a field list object 452 that supports a variety of field service work orders, each having diverse data fields.

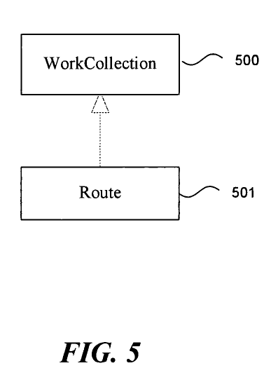

Because meter servicing and reading events are rarely performed in isolation, it may be useful to group such events into work collections. Accordingly, the data model may provide for a WorkCollection data type 500, as shown in the class diagram of FIG. 5. The WorkCollection data type 500 contains a collection of work or work orders. Because types of work can vary (e.g., meter reading work, field service work, telemetry monitoring and control work, etc.) the WorkCollection data type 500 can be used to generically manage requests and responses for varying types of work.

In some embodiments, the WorkCollection data type 501 can be specialized to add additional characteristics (e.g., geographic information about the meters associated with the work collection), while still allowing it to be passed through any interface that accepts a generic work collection (such as the work interfaces 116 and 216 of FIGS. 1 and 2, respectively). An example of such a specialized work collection is a Route data type 501 used to organize a collection of meter management events taking place in a set geographical area. As shown, the Route data type 501 inherits from the WorkCollection data type 500. Geographic information for the route, as well as scheduling information, etc., may all be incorporated using the Route data type 501. In a practical sense, the use of the Route data type 501 allows multiple work orders in the route to be assigned to a particular person, possibly on a designated schedule. While not illustrated, other specialized types of work collections may be implemented such as work collection data types for infrastructure related work, etc.

IV. System Flows

Referring to FIGS. 6 and 7, various flow diagrams show processes that occur within components or layers of the systems (100 and 200) of FIGS. 1 and 2, respectively. The blocks at the center of the diagrams show the components or layers (using the same reference numbers referred to in FIGS. 1 and 2) in which the routines are taking place. These flow diagrams do not show all functions or exchanges of data but, instead, provide an understanding of commands and data exchanged under the system. Those skilled in the relevant art will recognize that some functions or exchanges of commands and data may be repeated, varied, omitted, or supplemented, and other aspects not shown may be readily implemented. Fore example, both FIGS. 6 and 7 refer to parsing of a file. A file is but one type of data transport techniques that can be used in implementing the invention. For example, instead of a file, data may be transmitted through a message queue, over HTTP, etc.

Referring to FIG. 6, a receive work routine 600 starts at the CIS 108 and a return work results routine 650 starts at the field device layer 112. At block 601 of the receive work routine 600, after a file containing work requests is imported from the CIS 108, a CIS data formatter component (e.g., file parser—not shown) at the import/export data management layer 118 parses the imported file containing work requests. At block 602, the import/export data management layer 118 extracts work from the imported file and passes the work (in the form of work orders) to the collection system application server 114 via the work collection interface. At block 603, the collection system application server 114 proceeds to download work onto the field device layer 112 (this download event might also use an IWorkCollection concept). After block 603 the routine 600 ends.

The return work results routine 650, which is performed after utility work has been completed, begins at block 651, where the collection system application server 114 uploads work results (e.g., meter read information, meter status information, etc.) from the field device layer 112. At block 652, work results are passed to the import/export data management layer 118. At block 653 the CIS data formatter component at the import/export data management layer 118 builds an export file to send to the CIS 108. The file is exported to the CIS and the routine 650 then ends.

The routines (600 and 650) of FIG. 6 are implemented in a system without a work broker. In contrast, FIG. 7 corresponds to routines (700 and 750) implemented in a system having a work broker 218. The work broker 218 allows the system to simultaneously support various meter and utility work management techniques using a single interface. For example, with the work broker 218 in place, the system may simultaneously support EMR, OMR, and AMR with a single interface. At a high level, the routines of FIG. 6 can be identified as “Parse Data to Import Work from Transport” and “Send Data through Transport to Export Work.“

Referring to FIG. 7, a receive work routine 700 starts at the CIS 208 and a return work results routine 750 starts at the field device layer 212. The receive work routine 700 begins at block 701 where a CIS data formatter component parses an imported file containing work requests. At block 702, the import/export data component 218 extracts work from the imported file and passes the work to the data management layer 220 via the IWorkCollection interface. At block 703, the data management layer 220 distributes work (e.g., in the form of work orders) to the appropriate collection system application server 214, also via the IWorkCollection interface. For example, work for meters set up to be managed by EMR techniques may be sent to a first collection system application server and work for meters to be managed by AMR techniques may be sent to a second head-end processor. At block 704, the appropriate collection system application server 214 proceeds to download work onto the field device layer 212. After block 704, the routine 700 ends.

The return work results routine 750 begins at block 751, where collection system application server 214 uploads work results from the field device layer 212. At block 752, work results are passed to the data management layer 220 via the IWorkCollection interface. At block 753, the data management layer 220 passes work results to the import/export data management layer 212, also via the IWorkCollection interface. At block 704, the CIS data formatter component builds an export file to send to the CIS 208. The file is exported to the CIS 208 and the routine 750 then ends.

To further illustrate the above described processes, Tables 2 and 3 below detail the states of a unit of work (e.g. a route or an individual work order) as it is passed through various layers or components of the system.

Table 2: Work States at Work Broker

Imported (into Work Broker)

Distributed to Collection System Application Server

Results returned from Collection System Application Server

Forced Complete

Exported (Configurable: Export Completed, by cycle or other rules)

Backed up

Reported On

Stats

Work Changed (Input:output)

Restored

Re-routed

Re-sequenced

Table 3: Work States at Collection System Application Server

Received from Work Broker

Assigned

Dispatched

Downloaded

Uploaded

Sent to Work Broker and done

Sent to Work Broker

Field Worker Stats

Received

Accepted

In Route (to the work order)

In Process

Canceled

Results Returned

Conclusion

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps or components are presented in a given order, alternative embodiments may perform routines having steps or components in a different order. The teachings of the invention provided herein can be applied to other systems, not necessarily the network communication system described herein. The elements and acts of the various embodiments described above can be combined to provide further embodiments and some steps or components may be deleted, moved, added, subdivided, combined, and/or modified. Each of these steps may be implemented in a variety of different ways. Also, while these steps are shown as being performed in series, these steps may instead be performed in parallel, or may be performed at different times.

Unless the context clearly requires otherwise, throughout the description and the claims, the words “comprise,” “comprising,” and the like are to be construed in an inclusive sense as opposed to an exclusive or exhaustive sense;

that is to say, in the sense of “including, but not limited to.” Words in the above detailed description using the singular or plural number may also include the plural or singular number respectively. Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The teachings of the invention provided herein can be applied to other systems, not necessarily the system described herein. These and other changes can be made to the invention in light of the detailed description. The elements and acts of the various embodiments described above can be combined to provide further embodiments.

This application is related to the following commonly assigned U.S. Patent Applications: U.S. Patent Application No. 60/500,507 (attorney docket no. 1725.173US01), filed on Sep. 5, 2003, entitled “System and Method for Detection of Specific On-Air Data Rate,” U.S. Patent Application No. 60/500,515 (attorney docket no. 1725.162US01), filed Sep. 5, 2003, entitled “System and Method for Mobile Demand Reset,” U.S. Patent Application No. 60/500,504 (attorney docket no. 1725.160US01), filed Sep. 5, 2003, entitled “System and Method for Optimizing Contiguous Channel Operation with Cellular Reuse,” U.S. Patent Application No. 60/500,479 (attorney docket no. 1725.156US01), filed Sep. 5, 2003, entitled “Synchronous Data Recovery System,” U.S. Patent Application No. 60/500,550 (attorney docket no. 1725.161US01), filed Sep. 5, 2003, entitled “Data Communication Protocol in an Automatic Meter Reading System,” U.S. patent application Ser. No. 10/655,760 (attorney docket no. 10145-8011.US00), filed on Sep. 5, 2003, entitled “Synchronizing and Controlling Software Downloads, such as for Utility Meter-Reading Data Collection and Processing,” and U.S. patent application Ser. No. 10/655,759 (attorney docket no. 10145-8012.US00), filed on Sep. 5, 2003, entitled “Field Data Collection and Processing System, such as for Electric, Gas, and Water Utility Data,” which are herein incorporated by reference. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above detailed description. While the above description details certain embodiments of the invention and describes the best mode contemplated, no matter how detailed the above appears in text, the invention can be practiced in many ways. Details of the system, data model, and management scheme may vary considerably in their implementation details, while still being encompassed by the invention disclosed herein. As noted above, particular terminology used when describing certain features, or aspects of the invention should not be taken to imply that the terminology is being re-defined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. A method for combined scheduling and managing of work in a utility system having meters for gathering data regarding utility usage, the method comprising:
providing a first data type configured for representing data associated with a first type of work event related to the utility system;
providing a second data type configured for representing data associated with a second type of work event related to the utility system, wherein the second type of work event is distinct from the first type of work event, and wherein the first or second work events include at least one of the following: investigating a possible tampering with one of the meters, an installation of a new meter, determining utility usage associated with one of the meters, and servicing one or more of the meters; and
receiving, via a user interface provided to a field technician for responding to work events, a first request to perform the first type of work event; and
receiving, via the user interface, a second request to perform the second type of work event.

2. The method of claim 1 wherein the first type of work event is associated with monitoring consumption of a utility associated with the utility system and wherein the second type of work event is associated with servicing one or more of the meters.

3. The method of claim 1 wherein the first data type and the second data type both inherit attributes from a common base data type.

4. The method of claim 1 wherein the interface is configured to determine a processing destination for the first request and a processing destination for the second request, and wherein the processing destination is based on a type of utility data collection system.

5. The method of claim 1, further comprising formatting the first request and the second request for distribution to at least one field service device.

6. A system for providing and processing work requests relating to reading and servicing utility meters, the system comprising:
a utility infrastructure system configured to provide a utility service, wherein the utility infrastructure system includes one or more utility meters that monitor consumption of the utility service;
a utility system configured for generating requests to perform work related to the utility infrastructure system, wherein each one of the requests to perform work is generated based a common underlying data structure, and wherein each one of the generated requests is either a request to perform work associated with monitoring consumption of the utility or a request to perform work associated with servicing the one or more utility meters; and
a work request and data collection system configured to process the generated requests to perform work, wherein the work request and data collection system includes:
a field device component configured to communicate with the one or more utility meters of the utility infrastructure system;
a data management component configured to parse and format the requests to perform work related to the utility infrastructure system;
an application server component configured to process the parsed and formatted requests and to transmit the processed requests to the field device component; and
a work interface component configured to facilitate communication between one or more components of the work request and data collection system.

7. The system of claim 6 wherein the utility system includes a billing component and a customer information component.

8. The system of claim 6 wherein the field device component supports a variety of meter reading techniques including at least one member of a set comprising electronic meter reading (EMR), off-site meter-reading (OMR), and automatic meter reading (AMR).

9. The system of claim 6 wherein the application server component supports various applications including at least one member of a set comprising meter reading applications, field service applications, and telemetry applications.

10. The system of claim 6 wherein the work interface component provides an interface between the data management component and the application server component.

11. The system of claim 6 wherein the requests to perform work include at least one member from a set comprising a request to perform a single meter read, a request to perform meter reads on a group of meters, a request perform field service on single meter, a request to perform field service on a group of meters, and a request to perform a combination of meter reading and servicing.

12. The system of claim 6 wherein the requests to perform work include at least one member from a set including a request to perform work associated with a connection event, a request to perform work associated with a disconnection event, a request to perform work associated with a replacement event, and a request to perform work associated with a verification event.

13. The system of claim 6 wherein at least one of the requests to perform work is associated with monitoring consumption of the utility by reading a meter, and wherein the reading of the meter includes performing a solid state meter read, an electromechanical meter read, or a special type of meter read.

14. The system of claim 6 wherein the field device component includes a display for displaying work orders to a field service worker, and wherein the field device component is configured for performing meter reading.

15. A system for providing and processing work requests relating to monitoring and servicing utility meters in a utility system that generates requests to perform work, the system comprising:
means for managing the generated requests to perform work, wherein the managing means includes:
means for receiving the request to perform work;
means for parsing and formatting the requests to perform work;
means for processing the parsed and formatted requests;
means for facilitating multiple types of requests to perform work, wherein the multiple types of requests to perform work include a request to perform work associated with monitoring the consumption of the utility and a request to perform work associated with servicing the utility meters; and
means for transmitting the processed requests to a field device component, wherein the field device component is configured for presenting an indication of the work in the processed request to a field service worker.

16. The system of claim 15 wherein the means for processing the parsed and formatted requests includes means for simultaneously supporting multiple meter management techniques.

17. The system of claim 15 wherein the field service device includes means for reading the utility meters.

18. The system of claim 15 wherein the field service device includes means for reprogramming the utility meters.

19. The system of claim 15, further comprising means for updating a request to perform work after the request has been transmitted to the field service device.

20. The system of claim 15, further comprising means for recalling a request to perform work after the request has been transmitted to the field service device.

21. A computer-readable medium having a data structure comprising:
information based on a work data entity, wherein the work data entity is used to generate work orders for monitoring data collection points associated with a utility system and for generating work orders for servicing the data collection points associated with the utility system; and
information for defining a work order, wherein the information for defining the work order includes instructions for monitoring one or more data collection points associated with the utility system or instructions for servicing one or more data collection points associated with the utility system.

22. The computer-readable medium of claim 21 wherein the generated work orders originate as a result of an automated scheduling feature.

23. The computer-readable medium of claim 21 wherein the information for defining the work order includes meter reprogramming information.

24. The computer-readable medium of claim 21 wherein the information for defining the work order includes meter reading information.

25. The computer-readable medium of claim 21 wherein the information for defining the work order includes survey information.

26. The computer-readable medium of claim 21 wherein the information for defining the work order includes transmission system information.

27. The computer-readable medium of claim 21 wherein the information for defining the work order includes distribution system information.

28. The computer-readable medium of claim 21 wherein the information for defining the work order includes infrastructure installation information.

29. The computer-readable medium of claim 21 wherein the information for defining the work order includes telemetry control information.

30. The computer-readable medium of claim 21 wherein the information for defining the work order includes safety inspection information.

31. The computer-readable medium of claim 21 wherein the information for defining the work order includes customer information, wherein the customer information includes account information, wherein the account information includes service point information, and wherein the service point information includes meter information.

32. The computer-readable medium of claim 21 wherein the information for defining the work order includes customer information, and wherein the customer information includes meter information.

33. A computer-readable medium having a data structure comprising:
information based on a work data entity, wherein the work data entity is used to generate a collection of work orders, including work orders for monitoring data collection points associated with a utility system and work orders for servicing the data collection points associated with the utility system; and
information for defining a collection of work orders, wherein the information for defining the collection work orders includes instructions for monitoring multiple data collection points associated with the utility system, instructions for servicing multiple data collection points in the utility, and instructions for monitoring and servicing multiple data collection points associated with the utility system.

34. The computer-readable medium of claim 33 wherein the collection of work orders comprises a meter reading route.

35. The computer-readable medium of claim 33 wherein the collection of work orders comprises a meter reading and meter servicing route.

36. A method for importing a work request used in reading and servicing gas, electric, or water meters in a utility system, the method comprising:
receiving a request to perform a work event associated with the utility system, wherein the request to perform a work event is generated based on an underlying data structure, and wherein the underlying data structure is used in generating requests for multiple types of work events, including meter monitoring work events and meter servicing work events;
processing the received request to generate a work order; and
transmitting the work order to a field device component.

37. The method of claim 36 further comprising:
uploading results of the work associated with the work order after work associated with the work order is performed;
processing the results of the work to generate an output file; and
exporting the output file to a customer information system associated with the utility system.

38. The method of claim 36 wherein the processing of the received request includes parsing and extracting data from the received request.

39. A method for importing a work request used in reading and servicing meters in a utility system that supports multiple meter management techniques, the method comprising:
receiving a request to perform a work event associated with the utility system, wherein the request to perform a work event is generated based on an underlying data structure, and wherein the underlying data structure is used in generating requests for multiple types of work events, including meter monitoring work events and meter servicing work events;
processing the received request to generate a work order, wherein the processing includes determining a type of data collection system associated with the request; and
based, at least in part, on the type of data collection system associated with the request, selecting one of multiple server components for performing additional processing of the received request;
communicating information from the received request to the selected one of the multiple application servers, wherein the selected one of the multiple application servers generates at least one work order based on the received request.

40. The method of claim 39 further comprising:
uploading results of the work associated with the work order after work associated with the work order is performed;
processing the results of the work to generate an output file; and
exporting the output file to a customer information system associated with the utility system.

41. The method of claim 39 wherein the selected one of the multiple application servers is associated with an automatic meter reading (AMR) system.

42. The method of claim 39 wherein the selected one of the multiple application servers is associated with an electronic meter reading (EMR) system.

43. The method of claim 39 wherein the selected one of the multiple application servers is associated with an off-site meter reading (OMR) system.

44. The method of claim 39 wherein the processing of the received request includes incorporating the processed request into a schedule of work orders.
